(19) United States
(12) Patent Application Publication
(10) Pub. No.: US 2026/0296782 A1
(43) Pub. Date: Oct. 1, 2026

(54) LOAD HANDLING DEVICE

(71) Applicant: Ocado Innovation Limited, Hatfield (GB)

(72) Inventor: Marek HAVEL, Prague (CZ)

(21) Appl. No.: 19/480,326

(22) PCT Filed: May 1, 2024
(86) PCT No.: PCT/EP2024/061992

§ 371 Date: Oct. 30, 2025

(30) Foreign Application Priority Data
May 2, 2023 (GB) 2306475.1

(51) Int. Cl. B65G 1/04; B65G 1/137

(52) U.S. Cl. CPC B65G 1/0464; B65G 1/0478; B65G 1/0492; B65G 1/1378

(57) ABSTRACT

A load handling device designed to operate on the top of a cubic automated storage and retrieval system (ASRS). The load handling device comprises a container lifting device that can lift a storage container from a storage location within the ASRS. The storage container can then be stored within the interior of the load handling device such that one or more product items may be picked from the storage container through an aperture in the top of the load handling device. The load handling device occupies only a single grid space of the cubic ASRS.

The disclosure relates to a load handling device, and in particular to a robotic load handling device which can be operated on a grid within a fulfilment centre.

### BACKGROUND

Grid-based automatic storage and retrieval systems are well known in the art. In such systems a plurality of robotic load handlers operate on a horizontal grid structure, underneath which is received a plurality of containers, arranged in a plurality of stacks. The containers are used to hold products and the load handlers are adapted to retrieve containers from one of the plurality of stacks and to deposit a container within one of the stacks. The load handlers may be routed in an autonomous manner (or a semi-autonomous manner) on the grid but a wireless communications system is required to transmit instructions to load handlers and to enable each of the load handlers to communicate with a management system. The claimed apparatus, methods, systems and computer programs are intended to provide improvements relating to communications systems for use in an automated retrieval and storage system which uses a fleet of robotic load handlers.

### SUMMARY

According to a first aspect of the present disclosure, there is provided a load handling device for use in a storage system, the storage system comprising a first set of parallel tracks extending in an X-direction, a second set of parallel tracks extending in a Y-direction transverse to the first set in a substantially horizontal plane to form a grid pattern comprising a plurality of grid spaces and a plurality of stacks of storage containers located beneath the tracks, and arranged such that each stack is located within a footprint of a single grid space; the load handling device comprising: a wheel assembly arranged to selectively move in the X-direction or the Y-direction; a container lifting device arranged, in use, to lift a container from one of the plurality of stacks into the interior of the load handling device; an aperture within the load handling device such that the volume of a container received within the load handling device can be accessed from above the load handling device wherein the load handling device has a footprint that occupies only a single grid space in the storage system, such that a load handling device occupying one grid space does not obstruct a load handling device occupying or traversing the adjacent grid spaces in the X and/or Y directions.

The load handling device may comprises one or more component modules mounted on a respective external face of the load handling device. In one example, each face of the load handling device may comprise a respective component module. The or each component module may be mounted the load handling device above the wheels of the wheel assembly.

This packaging of the components enables the interior of a container received within the load handling device to be accessed from above the load handling device. The component packaging also simplifies the repair of a load handling device which has a defective component (or components).

The load handling device may comprise a first halo which extends around the periphery of the device and is located above the one or more component modules. The load handling device may also comprise a second halo which extends around the periphery of the device and is located below the one or more component modules. The second halo may be located above the wheel assembly.

The load handling device may comprise one or more battery holders, the or each battery holder being located on the exterior of the load handling device. The or each battery holder may be located above the first halo. The or each battery holder may be located on one of the long sides of the load handling device. The placement of the battery holders on the exterior of the load handling device enables the interior of a container received within the load handling device to be accessed from above the load handling device.

According to a second aspect of the present disclosure, there is provided a storage system comprising: a first set of parallel tracks extending in an X-direction, and a second set of parallel tracks extending in a Y-direction transverse to the first set in a substantially horizontal plane to form a grid pattern comprising a plurality of grid spaces; a plurality of stacks of storage containers located beneath the tracks, and arranged such that each stack is located within a footprint of a single grid space; at least one load handling device as described above, the at least one transporting device being arranged to selectively move in the X and/or Y directions, above the stacks on the tracks and arranged to transport a storage container. The storage system may further comprise a picking station arranged to receive a storage container transported by the at least one transporting device and to transfer an item from the storage container into a delivery container.

### BRIEF DESCRIPTION OF THE DRAWINGS

The communication system will now be described in detail with reference to examples, in which:

FIG. 1 schematically illustrates a storage structure and containers;

FIG. 2 schematically illustrates track on top of the storage structure illustrated in FIG. 1;

FIG. 3 schematically illustrates load-handling devices on top of the storage structure illustrated in FIG. 1;

FIG. 4 schematically illustrates a single load-handling device with container-lifting means in a lowered configuration;

FIG. 5 schematically illustrates cutaway views of a single load-handling device with container-lifting means in a raised and a lowered configuration;

FIGS. 6 to 10 shows a schematic depiction of a load handling device according to the present disclosure; and

FIG. 11 shows a depiction of a flowchart showing the operation of a load handling device according to the present disclosure.

### Detailed Description of the Drawings

The following examples represent the applicant's preferred examples of how to implement a communications system for use with robots in a warehouse but they are not necessarily the only examples of how that could be achieved.

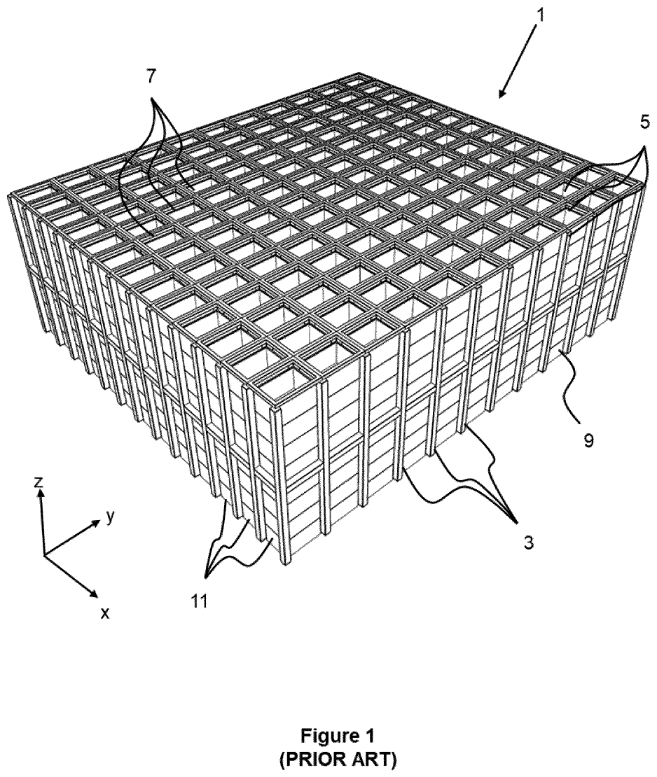

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

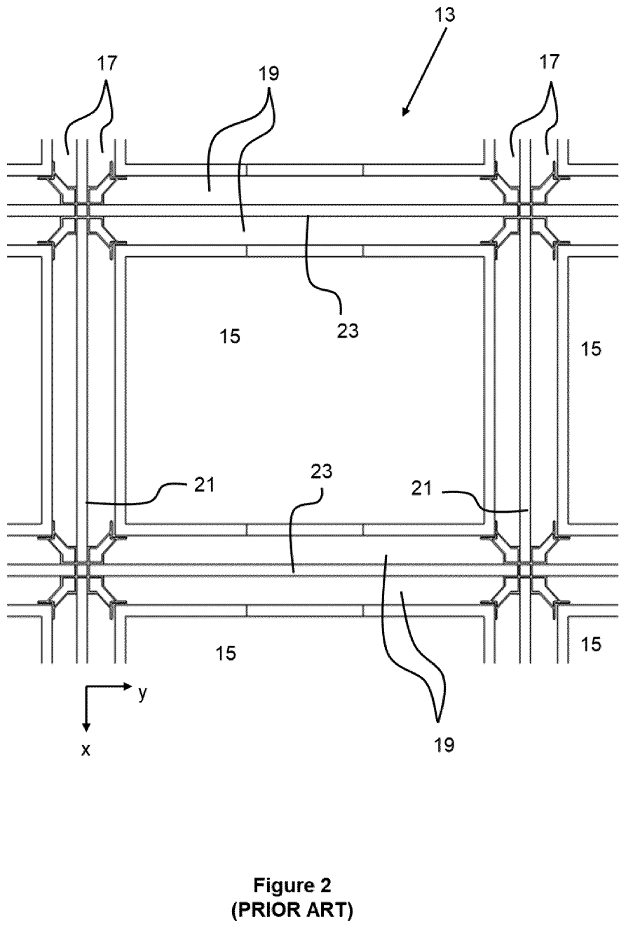

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

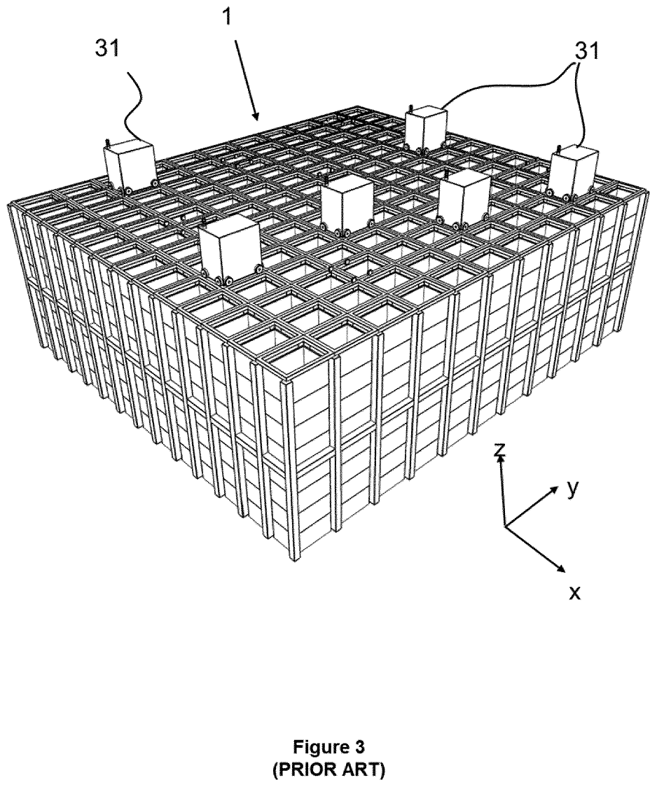

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

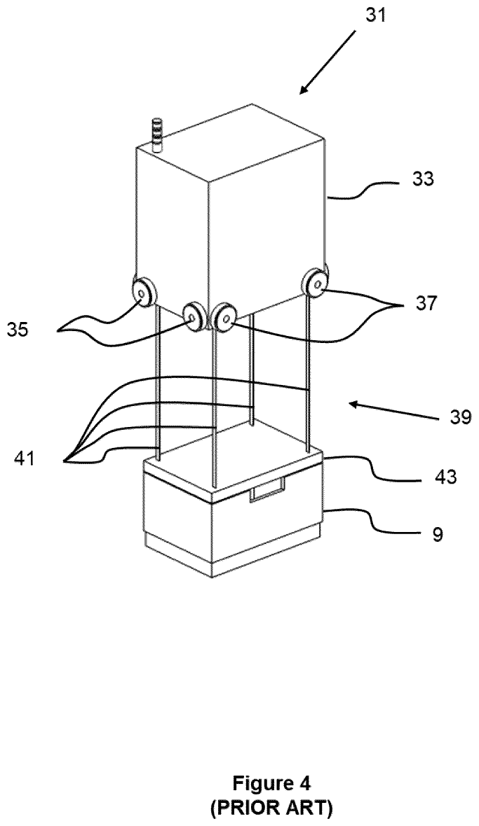

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

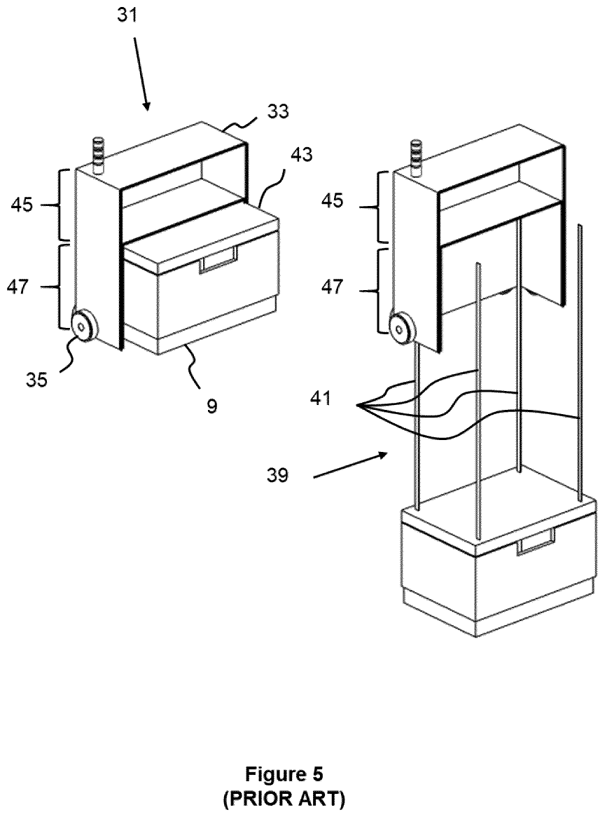

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, the upper and lower portions 45, 47 may not be physically divided by a specific component or part of the body 33 of the bot 31.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

To remove a container 9 from the top of a stack 11, the bot 31 is moved as necessary in the X and Y directions so that the container-gripping assembly 43 is positioned above the stack 11. The container-gripping assembly 43 is then lowered vertically in the Z direction to engage with the container 9 on the top of the stack 11. The container-gripping assembly 43 grips the container 9, and is then pulled upwards on the tapes 41, with the container 9 attached. At the top of its vertical travel, the container 9 is accommodated within the vehicle body and is held above the level of the tracks. In this way, the load handling device 30 can be moved to a different position in the X-Y plane, carrying the container 9 along with it, to transport the container 9 to another location. The tapes 41 are long enough to allow the load handling device 30 to retrieve and place containers from any level of a stack 11, including the floor level. The weight of the vehicle may be comprised in part of batteries that are used to power the drive mechanism for the wheels 35, 37.

As shown in FIG. 3, a plurality of load handling devices 31 are provided, so that each bot 31 can operate simultaneously to increase the throughput of the system. The system illustrated in FIG. 3 may include specific locations, known as ports, at which containers 9 can be transferred into or out of the system. An additional conveyor system (not shown) is associated with each port, so that containers 9 transported to a port by a bot 31 can be transferred to another location by the conveyor system, for example to a picking station (not shown). Similarly, containers 9 can be moved by the conveyor system to a port from an external location, for example to a container-filling station (not shown), and transported to a stack 11 by the bots 31 to replenish the stock in the system.

Each bot 31 can lift and move one container 9 at a time. If it is necessary to retrieve a container (“target container”) that is not located on the top of a stack 11, then the overlying containers (“non-target containers”) must first be moved to allow access to the target container. This is achieved in an operation referred to hereafter as “digging”. During a digging operation, one of the bots 31 sequentially lifts each non-target container 9a from the stack 11 containing the target container 9b and places it in a vacant position within another stack 11. The target container 9b can then be accessed by the bot 31 and moved to a port for further transportation.

Each of the bots 31 is under the control of a grid controller. Each individual container 9 in the system is tracked, so that the appropriate containers 9 can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers 9, while allowing reasonably economical access to all of the containers 9 when required for picking.

It should be understood that it is necessary for messages to be transmitted to the bots. These may be short messages, for example an instruction to move a container from a first location to a second location, or the messages may be larger, for example an update to the computer code which is used to operate the bot or a component of the bot. Similarly, it may be necessary for the bot to send messages to a central management system, for example to report operating parameter values, operating state reports etc. An example of a communications system which can be used is disclosed in the Applicant's international patent application WO 2015/185726.

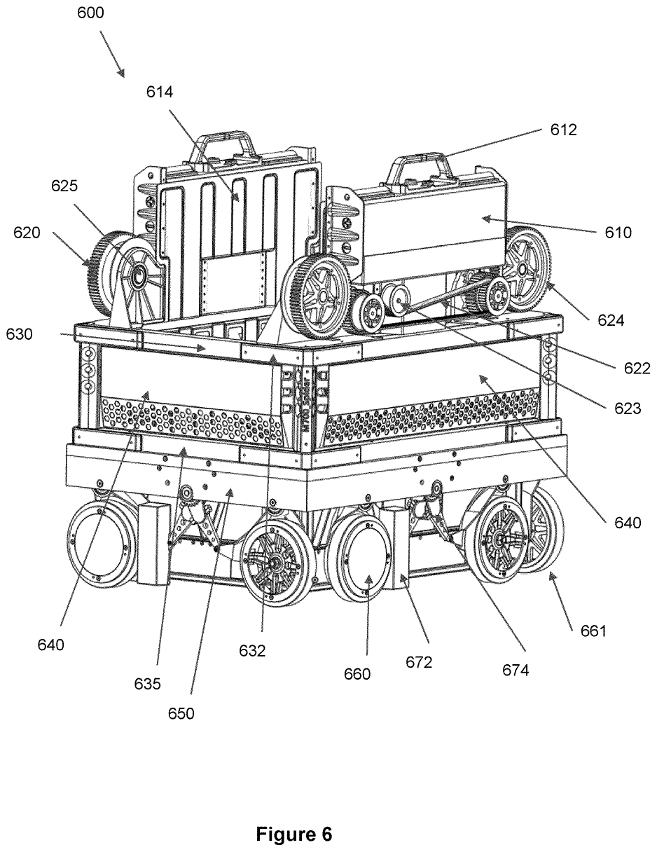

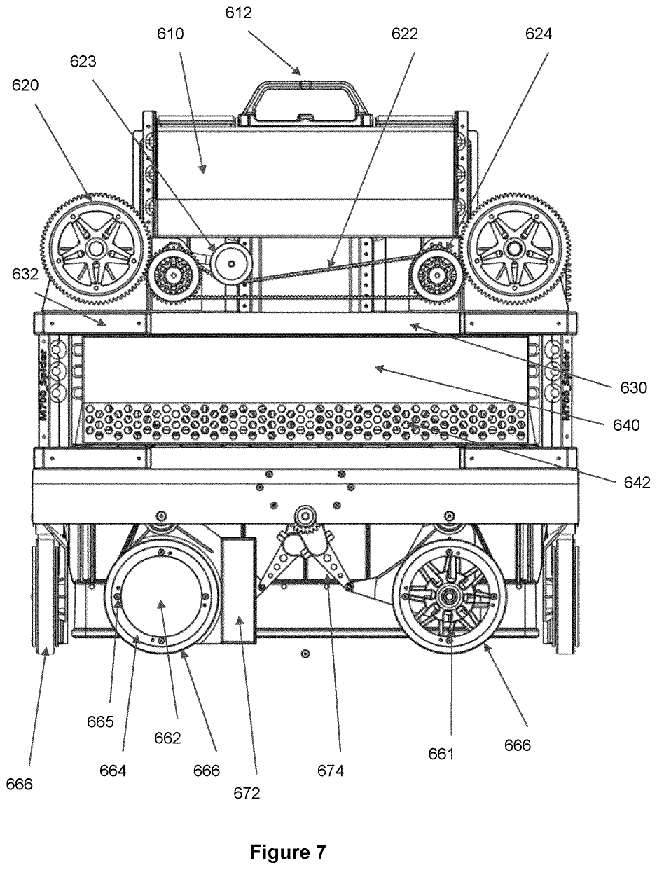

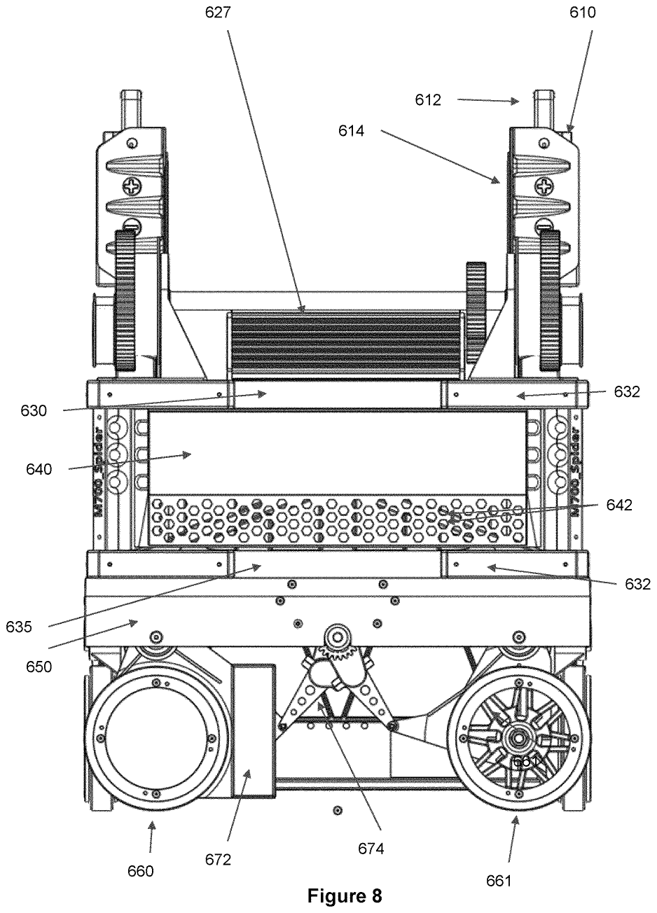

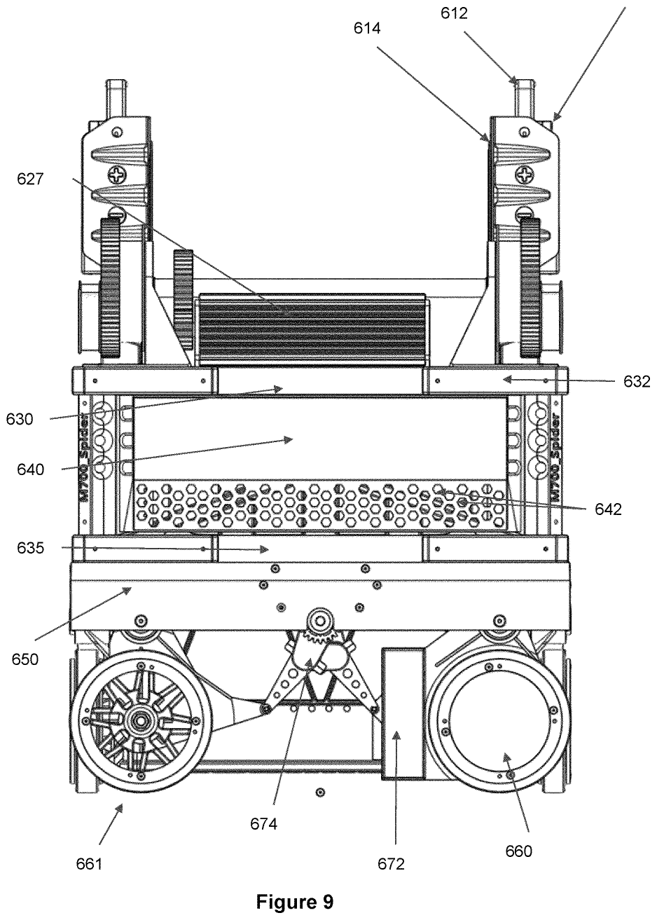

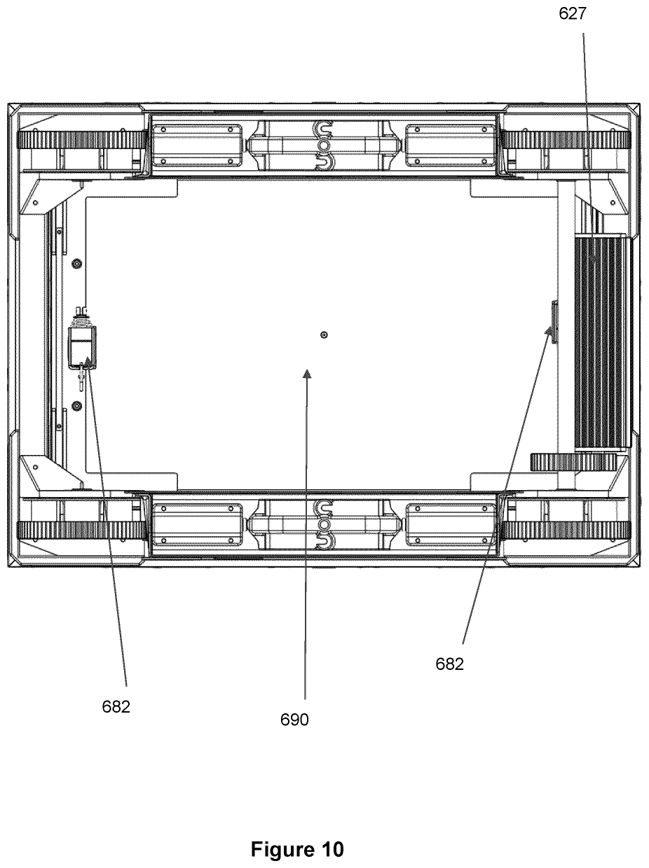

FIGS. 6 to 10 show schematic depictions of a load handling device 600 according to the present disclosure: FIG. 6 shows a perspective view of the load handling device; FIG. 7 shows a side view of the load handling device on its long side; FIG. 8 shows a side view of the load handling device on one of its short sides; FIG. 9 shows a side view of the load handling device on the other short side; and FIG. 10 shows a top view of the load handling device.

The load handling device, or bot, 600 has a rectangular profile such that the footprint of the bot fits within a single grid cell of a storage cell on which it will be in operation. Thus, a bot in the central grid cell of a 3×3 grid cell array can be surrounded by a bot in each of the neighbouring eight grid cells without there being any interference between any of the adjacent bots.

The bot comprises two batteries 610. Each of the batteries 610 are releasably received on a battery holder 614. The battery holders 614 (and thus a battery 610 attached thereto) are preferably located on the long edges of the bots. Each of the batteries may comprise a handle 612. The battery handle may enable the replacement of a discharged (or partially discharged) battery with a recharged battery. Such a battery replacement process may be performed manually or using an automated process, for example by the use of a device having a movable manipulator. Examples of battery exchange methods are disclosed in the Applicant's co-pending applications WO2023/017184 and PCT/EP2023/051832, the contents of which are herein incorporated by reference.

It should be understood that the bot may operate using only a single battery, although this will reduce the time in between battery exchange. Alternatively, the bot may be provided with more than two batteries.

As discussed above, the bot comprises a container lifting device. The container lifting device comprises hoist drive motor 627, first hoist drive wheel set 620 and second hoist drive wheel set 624. The second hoist drive wheel set 624 is connected by a drive belt 622. The first hoist drive wheel set 620 and second hoist drive wheel set 624 are mounted to the bot on the first hoist drive wheel set mount 625 and the second hoist drive wheel set mount 626 respectively. The hoist drive motor is arranged to drive one or both wheels of the first hoist drive wheel set using a drive shaft (not shown), the effect of which is to cause the container lifting device to be lowered or raised, as appropriate, through the movement of the first and second hoist wheel sets and the drive belt.

Referring to FIG. 9, the container lifting device further comprises gripper activators 682. When the container lifting device is lowered such that it is adjacent to the top of a container stored in a stack beneath the grid then the gripper activators 682 can be actuated such that a container can be acquired by the container lifting device. The hoist drive motor can then be activated such that the container is lifted such that the container is received within the interior of the bot. In this position, the bottom of the container is located above the surface of the grid such that bot is free to move across the grid. It should be appreciated that the container lifting device may be implemented in a different manner using different components in order to achieve the same effect.

The bot comprises first and second haloes 630 635 which extend around the periphery of the bot. Located in between the first halo 630 and the second halo 635 are one or more component modules 640. In one example, each face of the bot comprises a component module but it should be understood that a bot may comprise fewer than four component modules. The component module(s) hold the electronic circuitry that is used to control the operation of the bot, send and receive messages to and from the central management system of the fulfilment centre, etc. The component module(s) may comprise additional components, for example a backup battery to retain operating and configuration data that might otherwise be lost during an exchange of the batteries 610. Each of the component modules may comprise connectors and/or cabling that enables them to be connected to a further component module. The cabling may be routed through the corners between adjacent component modules.

The outer faces of the component modules may comprise a region in which are formed a plurality of ventilation apertures 642. The ventilation apertures are provided to allow airflow through the interior volume of the component module(s), such that heat generated by the components received therein can be dissipated outside of the module(s). The inside faces of the component module(s) (not shown in FIGS. 6 to 9) may also comprise a region in which a further plurality of ventilation apertures are formed. The ventilation apertures formed in the inner and outer faces may be configured to facilitate the flow of air from the interior of the bot to the exterior, through the component module(s) such that heat can be vented away from the interior of the bot. The interior structure may be configured to facilitate such an airflow.

By providing the components in a modular form a defective bot may be repaired by the replacement of the appropriate module. In an alternative, a component module which comprises a defective component (or components) may be disconnected from the other modules, opened up and the defective component(s) replaced. The repaired module could then be re-connected to the other modules such that the bot can be recommissioned.

This aspect of the bot design avoids the need to open the bot to access a defective component and then replace it. This allows a bot to be repaired more simply within a fulfilment centre.

Halo bumpers 632 may be located on each corner of the first and second haloes 630, 635. The halo bumpers extend the footprint of the bot beyond that defined by the direction change mount 650 and the wheels 660 661 such that the halo bumpers define the greatest extent of the bot footprint. In the event that a bot overshoots the target grid cell then it may collide with another bot present in the adjacent grid cell. The bot-to-bot contact will be the contact between the respective halo bumpers. This should reduce the forces that will act on the bot structure and components. The presence of the bot haloes may prevent damage from occurring to the bot, or reduce the extent of any damage.

The halo bumper(s) may be formed from a deformable material, which may deform permanently or elastically. In an alternative, the halo bumper(s) may be formed from a material that shatters on impact.

Each face of the bot comprises a drive set, with each of the drive sets comprising a drive wheel 660, passive wheel 661 and drive wheel controller 672. The drive set is further connected to a direction connection mechanism 674. Each drive wheel 660 comprises a hub motor 662. In operation, the drive wheel controller 672 causes the hub motor to be selectively actuated, such that the drive wheel is rotated in a selected direction. Each wheel preferably comprises a tyre 666 received around the wheel. The tyre may be secured on the wheel using a retaining member, which may take the form of an annular ring. The retaining member may be secured to the wheel using one or more securing mechanisms, for example a threaded bolt. Thus, when a tyre has exceeded its service life, the retaining member may be removed from the wheel, such that the tyre can be removed and replaced.

As discussed above with reference to FIGS. 3 to 5, the bot needs to be able to move across the top surface of the grid in both the X and Y directions, and to be able to change between the X direction and the Y direction, and vice versa. When the bot is configured to move in a first direction then the direction change mechanism 674 will be configured such that the drive sets on two opposed faces of the bot are in contact with the rails of the grid and the drive sets on the other two opposed faces of the bot are raised such they are clear of the grid rails. The bot can then move in the first direction, through the application of appropriate signals from the drive wheel controller 672 to the hub motors of the drive wheels 660. When it is required that the bot changes direction, i.e. that the bot moves in the second direction at right-angles to the first direction then the direction change mechanism is activated such that the raised opposed drive sets are lowered onto the grid rails and the other opposed drive sets are lifted from the grid rails. In one example, the direction change mechanism may be that as described in the Applicant's co-pending application, WO2022/058550 A1, the contents of which are herein incorporated by reference.

The direction change mechanism is connected to a direction change mount 650, which is connected to the frame of the bot. The direction change mount may take the form of an inverted U-shape, such that the inner arm of the U-shape is connected to the frame of the bot and the outer arm covers a portion of the direction change mechanism above the level of the wheels. The direction change mechanism 672 is received within the channel formed by the inner and outer arms of the direction change mount. As can be seen in FIGS. 7 to 9, the wheels may extend beyond the footprint of the direction change mount 650.

FIGS. 6 to 8 show that each face of the bot has an associated drive wheel controller. In an alternative example, the bot may comprise two drive wheel controllers, such that, for example, the first drive wheel controller is associated with the two opposed longer faces of the bot and the second drive wheel controller is associated with the two opposed shorter faces of the bot. In a further alternative, the drive wheel controller functionality may be provided using components received within one or more of the component modules 640.

It will be understood that it is necessary for the position of the bot relative to the grid to be determined accurately and repeatedly. It is known in similar bots that a ‘fifth wheel’ may be installed, the rotations of which can be used to determine the movement of the bot in a given direction (see the Applicant's co-pending application WO 2022/136454, the contents of which are herein incorporated by reference). In the present disclosure, one or more of the passive wheels may be used in a similar manner, with a suitable sensor (for example, a rotary encoder or similar sensor) used to measure the rotation of the passive wheel as the respective drive wheels move the bot on the grid. If the passive wheels on two opposed bot faces are used in such a manner an average value may be used to determine the displacement of the bot. Alternatively, if the displacement determined from one of the passive wheels is greater than the displacement determined from the opposed passive wheel then this may mean that the bot is becoming misaligned with the grid, potentially leading to the bot becoming derailed.

Other techniques for determining the location of a bot are known and may be used in conjunction with, or instead of, the sensing of the movement of the passive wheels. For example, the bot may comprise sensors to determine the location of barcodes, or other indicia, which are located on the track (see the Applicant's co-pending application, WO 2019/170805 A1, the contents of which are herein incorporated by reference). Furthermore, the bot may comprise sensors to determine the location of RFID sensors embedded within the grid (see the Applicant's co-pending application, WO 2020/148315 A1, the contents of which are herein incorporated by reference). A further technique is disclosed in the Applicant's co-pending application, WO2019/122080 A1, the contents of which are herein incorporated by reference, in which timing data derived from signals received from multiple base stations can be used to determine the location of a bot. It should be understood that one or more of these additional techniques may be used in conjunction with the determination of the position of the bot based on the data derived from the passive wheels.

In operation, the central management system will send an instruction to a bot to retrieve a container from the storage system and then move to a predetermined position adjacent, or near to, a picking station such that a robotic picking arm may pick one or more product items from the container. The picking station may be static or mobile, and examples of such picking stations are disclosed in the Applicant's co-pending application WO 2017/081275. The required product items may be retrieved from the container and transferred to a further container for subsequent storage or delivery. The bot may then take the container to a further picking station for a further picking operation to be performed or the bot may be returned to a predetermined location such that it is stored within the storage system.

FIGS. 6 to 9 show that the long sides of the bot comprise the battery and the hoist mechanisms. It can be seen that these features would complicate the picking process as a robotic picking arm would need to reach over them to access the internal volume of the container. Thus, it is preferred if the robotic picking arm can be configured such that it can access the internal volume of the container via one of the shorter sides of the bot.

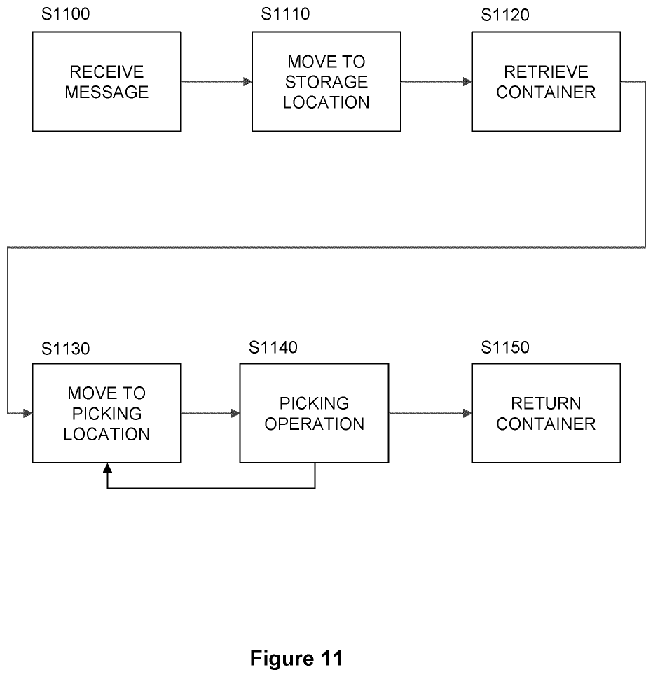

The operation of a bot according to the present disclosure will now be described with reference to the flowchart shown in FIG. 11. In operation a bot will receive a message (S1100) from the central management system of the fulfilment centre, the message comprising a location within the storage system and a route to take to move to that location. The bot will then move to the specified location (S1110). Once the bot has reached that location, the bot will retrieve the storage container (S1120) which is at the top of the stack of containers at the location. The bot will lower the container lifting device until it makes contact with the storage container. The gripper activators can then be actuated so that the container lifting device secures the storage container such that the storage container can be lifted into the interior of the bot. In this position, the storage container is lifted clear of the level of the grid such that the bot is able to move across the grid.

The bot will send a message to the central management system to confirm that the storage container has been retrieved. In response, the central management system will send a further message to the bot, the further message comprising a picking location, that is a location within the storage system which is adjacent to a picking station and a route to take to navigate to that location. The bot will then move to that picking location (S1130) such that one or more product items can be picked from the bot during a picking operation (S1140). The picking operation is undertaken by the robotic arm of the picking station reaching into the interior of the storage container received within the bot and picking the required product items.

After the picking operation is complete, the central management system may send a message which comprises a second storage location. The bot will then, in response, move to the second storage location and return the storage container to the storage system (S1150). The second storage location may be the same location that the storage container was retrieved from in step S1120. Alternatively, it may be a different location elsewhere in the storage system. Alternatively, the message sent by the central management system after the completion of the picking operation may comprise a further picking location, such that the bot moves to a position adjacent to a further picking station, such that one or more product items may be picked from the storage container through the top of the bot. Examples of picking stations which are suitable for use with a bot according to the present disclosure are disclosed in the applicant's co-pending applications WO2017/081275 and WO2023/285487.

In one regard, the present disclosure provides a load handling device designed to operate on the top of a cubic automated storage and retrieval system (ASRS). The load handling device comprises a container lifting device that can lift a storage container from a storage location within the ASRS. The storage container can then be stored within the interior of the load handling device such that one or more product items may be picked from the storage container through an aperture in the top of the load handling device. The load handling device occupies only a single grid space of the cubic ASRS.

1. A load handling device for use in a storage system, the storage system comprising a first set of parallel tracks extending in an X-direction, a second set of parallel tracks extending in a Y-direction transverse to the first set in a substantially horizontal plane to form a grid pattern comprising a plurality of grid spaces and a plurality of stacks of storage containers located beneath the tracks, and arranged such that each stack is located within a footprint of a single grid space; the load handling device comprising:
a wheel assembly arranged to selectively move in the X-direction or the Y-direction;
a container lifting device arranged, in use, to lift a container from one of the plurality of stacks into the interior of the load handling device;
an aperture within the load handling device such that the volume of a container received within the load handling device can be accessed from above the load handling device wherein the load handling device has a footprint that occupies only a single grid space in the storage system, such that a load handling device occupying one grid space does not obstruct a load handling device occupying or traversing the adjacent grid spaces in the X and/or Y directions.

2. A load handling device according to claim 1, wherein the wheel assembly comprises a direction change mechanism configured, in use, such that the load handling device can change movement between the X-direction and the Y-direction.

3. A load handling device according to claim 1, wherein the wheel assembly comprises a first set of wheels arranged to move the load handling device in the X-direction and a second set of wheels arranged to move the load handling device in the Y-direction.

4. A load handling device according to claim 3, wherein the first set of wheels comprises two wheels located on a first side of the load handling device and two further wheels located on the opposed side of the load handling device such that the wheels are arranged to move the load handling device in the X-direction.

5. A load handling device according to claim 3, wherein the second set of wheels comprises two wheels located on a second side of the load handling device and two further wheels located on the opposed side of the load handling device such that the wheels are arranged to move the load handling device in the Y-direction.

6. A load handling device according to claim 1, wherein the load handling device comprises one or more component modules, component module being mounted on a respective external face of the load handling device.

7. A load handling device according to claim 6, wherein each component module is mounted on an external face of the load handling device above the respective wheels.

8. A load handling device according to claim 6, wherein a plurality of component modules are interconnected.

9. A load handling device according to claim 6, wherein the load handling device comprises a first halo which extends around the periphery of the device and is located above the one or more component modules.

10. A load handling device according to claim 9, wherein the load handling device comprises a second halo which extends around the periphery of the device and is located below the one or more component modules.

11. A load handling device according to claim 10, wherein the second halo is located above the wheel assembly.

12. A load handling device according to claim 1, wherein the load handling device comprises one or more battery holders, battery holder being located on the exterior of the load handling device.

13. A load handling device according to claim 12, wherein,
the load handling device comprises one or more component modules, each component module being mounted on a respective external face of the load handling device;
the load handling device comprises a first halo which extends around the periphery of the device and is located above the one or more component modules;
the load handling device comprises one or more battery holders, each battery holder being located on the exterior of the load handling device; and
each battery holder is located above the first halo.

14. A load handling device according to claim 13, wherein each battery holder is located on the long side of the load handling device.

15. A load handling device according to claim 1, wherein the container lifting device comprises a container lifting motor and one or more lifting wheel sets, the wheel sets being arranged to raise or lower the container lifting device.

16. A storage system comprising:
a first set of parallel tracks extending in an X-direction, and a second set of parallel tracks extending in a Y-direction transverse to the first set in a substantially horizontal plane to form a grid pattern comprising a plurality of grid spaces;
a plurality of stacks of storage containers located beneath the tracks, and arranged such that each stack is located within a footprint of a single grid space;
at least one transporting device according to any of claims 1 to 15, the at least one transporting device being arranged to selectively move in the X and/or Y directions, above the stacks on the tracks and arranged to transport a storage container.

17. A storage system according to claim 16, further comprising a picking station arranged to receive a storage container transported by the at least one transporting device and to transfer an item from the storage container into a delivery container.
